(19) United States
(12) Patent Application Publication
(10) Pub. No.: US 2026/0132669 A1
(43) Pub. Date: May 14, 2026

(54) DOOR HEADER

(71) Applicant: Ghislain BÉLANGER, Rivière-des-Prairies (CA)

(72) Inventor: Ghislain BÉLANGER, Rivière-des-Prairies (CA)

(21) Appl. No.: 19/385,346

(22) Filed: Nov. 11, 2025

Related U.S. Application Data
(60) Provisional application No. 63/719,348, filed on Nov. 12, 2024.

(51) Int. Cl. E06B 1/02

(52) U.S. Cl. CPC E06B 1/02

(57) ABSTRACT

A door header of a frame defines an opening in a stud wall having two adjacent vertical studs spaced from one another. The door header includes an elongate body with at least a main bottom wall and first and second longitudinal lateral walls secured to the bottom wall and being generally perpendicular thereto. First and second longitudinal end brackets, slidably inserted and secured to the metallic elongate body adjacent the longitudinal ends, are securable to the vertical studs. Each longitudinal end bracket includes an end wall with two opposed side tabs, and opposed lower and upper tabs, with all tabs extending perpendicularly from the end wall opposite a stud facing surface thereof. At least one of the side tabs and the lower tab are securable to the first and second lateral walls and the bottom wall, respectively.

### CROSS REFERENCE TO RELATED APPLICATIONS

This application claims priority of U.S. Provisional Application for Patent No. 63/719,348 filed on Nov. 12, 2024, the content of which is incorporated herein by reference in its entirety.

### TECHNICAL FIELD OF THE INVENTION

The present invention relates to wall construction, and in particular to a door header of a stud wall, or horizontal portion of a frame defining an opening in the stud wall.

### BACKGROUND OF THE INVENTION

Use of U-shaped metal studs in the assembly of stud walls, especially metallic studs, in building construction is well known in the art. Typically, such stud walls include a plurality of spaced apart vertical studs mounted between a floor bottom horizontal stud (or lower channel) and a ceiling top horizontal stud (or upper channel). When an opening has to be defined in the stud wall, for a doorway or a window for example, each opening is defined with a frame. In the case of a doorway, the two vertical studs forming the frame are spaced from one another with a predetermined distance, and a door header (or top horizontal portion of the frame) is placed therebetween at a predetermined height, while the floor bottom stud is typically removed therebetween. In the case of a window opening, the two vertical studs forming the frame are spaced from one another with a predetermined distance, and top and bottom horizontal portions of the frame (or header and sill) are placed therebetween at respective predetermined heights.

However, the installation of these door headers is usually very time consuming (in the order of 10-15 minutes in average), which is in turn very costly, especially when considering that a single apartment may include at least ten doors and a few windows and that a building under construction includes tens or hundreds of such apartments. In fact, each door header requires the skilled technician to first cut the piece at the predetermined width and then to install it at the exact predetermined height (and in a perfect horizontal orientation) by securing it to the two vertical studs defining the frame. The installation requires the technician to first mark the proper location on the vertical studs and then secure the horizontal portion of the frame thereto while holding it in place, which could be really cumbersome and time consuming, depending on the length, and sometimes the weight, of the door header.

Accordingly, there is a need for an improved door header.

### SUMMARY OF THE INVENTION

It is therefore a general object of the present invention to provide an improved door header that obviates the above-mentioned problems and drawbacks.

An advantage of the present invention is that the door header has predetermined body length.

Another advantage of the present invention is that the door header is made of metallic main body, typically ready to be installed since longitudinal end brackets are secured thereto, with each end bracket being typically shaped (by folding a blank or the like from a metallic sheet, with an end wall having at least two opposed side tabs, and preferably two opposed lower and upper tabs, all tabs extending generally perpendicularly therefrom on a same side of the end wall) prior to its slidable insertion and securing at the respective longitudinal end. At least one intermediate bracket (typically similar to the end brackets) can be added and secured thereto, typically by sliding and pivoting insertion, at any selected location between the two longitudinal ends to provide for abutment and securement to an intermediate stud. All the tabs have a typically flexible and resilient attachment (interface or folding line) to the end wall to allow selective angular positioning for easier insertion into the main body.

A further advantage of the present invention is that the door header is relatively lightweight although rigid enough to secure a door frame thereto.

Still another advantage of the present invention is that the door header can also be used as a window header or sill.

Yet another advantage of the present invention is that the door header can be easily maintained in proper position adjacent the vertical studs of a stud wall using installation tools typically using magnetic-type fasteners to simultaneously removably secure to the vertical stud and removably supporting the door header prior and during its attachment to the vertical studs.

According to an aspect of the present invention, there is provided a door header of a frame defining an opening in a stud wall having two adjacent vertical studs spaced from one another by a predetermined distance, the door header comprising:
a metallic elongate body including at least a main bottom wall and first and second longitudinal lateral walls secured to the bottom wall and being generally perpendicular thereto, the main bottom wall and the longitudinal lateral walls extending between first and second longitudinal ends, the metallic elongate body having a body length generally equal to the predetermined distance;
first and second longitudinal end brackets slidably inserting and securing to the metallic elongate body adjacent the first and second longitudinal ends, respectively, the first and second longitudinal end brackets being securable to the two adjacent vertical studs;
wherein each one of said first and second longitudinal end brackets including a bracket end wall with two opposed bracket side tabs, and opposed bracket lower and upper tabs, all extending generally perpendicularly from the bracket end wall opposite a stud facing surface of the bracket end wall, at least one of the two opposed bracket side tabs and the bracket lower tab being securable to the first and second longitudinal lateral walls and the main bottom wall, respectively, when each said longitudinal end bracket is secured at respective said longitudinal end.

In one embodiment, the bracket end wall of each said longitudinal end bracket includes at least one perforation extending there through to allow a fastener to be insertable through the at least one perforation, thereby securing the longitudinal end bracket to one of the two adjacent vertical studs.

In one embodiment, the door header further includes a third end bracket with the two opposed bracket side tabs secured to the metallic elongate body between the first and second longitudinal ends, the bracket end wall of the third end bracket being securable to a longitudinal end of a third vertical stud slidably inserted into the metallic elongate body adjacent the third end bracket, the first and second longitudinal lateral walls being securable to the third vertical stud.

In one embodiment, each said bracket side tab includes a flap extending therefrom opposite the bracket end wall and angled toward the other said bracket side tab.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a partially broken schematic top perspective view of a door header of a frame in accordance with an embodiment of the present invention, showing the door header held in position between adjacent metallic vertical studs by respective installation tools releasably mounted on the respective studs, and supporting an intermediate stud there between;

FIG. 2 is an enlarged exploded top perspective view of the door header of FIG. 1, showing the different parts, i.e. the elongate body and the end brackets before assembly; and

FIGS. 3 to 5 are enlarged perspective views of one of the end brackets of FIG. 2, showing different sides thereof.

### DETAILED DESCRIPTION OF THE INVENTION

With reference to the annexed drawings the preferred embodiment of the present invention will be herein described for indicative purpose and by no means as of limitation.

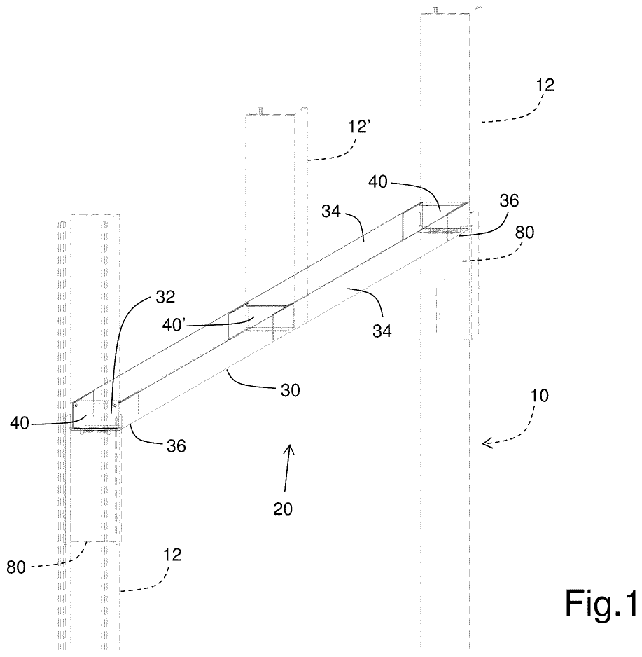

Referring now to FIGS. 1 to 5, therein is shown, in accordance with an embodiment of the present invention, a door header 20 of a frame 22 defining an opening in a stud wall 10 having two adjacent vertical studs 12 spaced from one another by a predetermined distance (such as commonly used 26, 28, 30, 32, 34, 36 or 38 inch wide doors, for examples, or any other dimension for a window opening and the like). All vertical studs 12 of a same stud wall 10 have a common stud width, namely 5.5 inches, 3.5 inches or 2.5 inches, from the typical nominal 2×6, 2×4 or 2×3 studs used in building walls. The door header 20, as seen in FIG. 1, is adapted to be in abutment with the two adjacent vertical studs 12 of the stud wall 10 and typically supported by two installation tools 80 for the installation and securing of the door header 20 to the vertical studs 12.

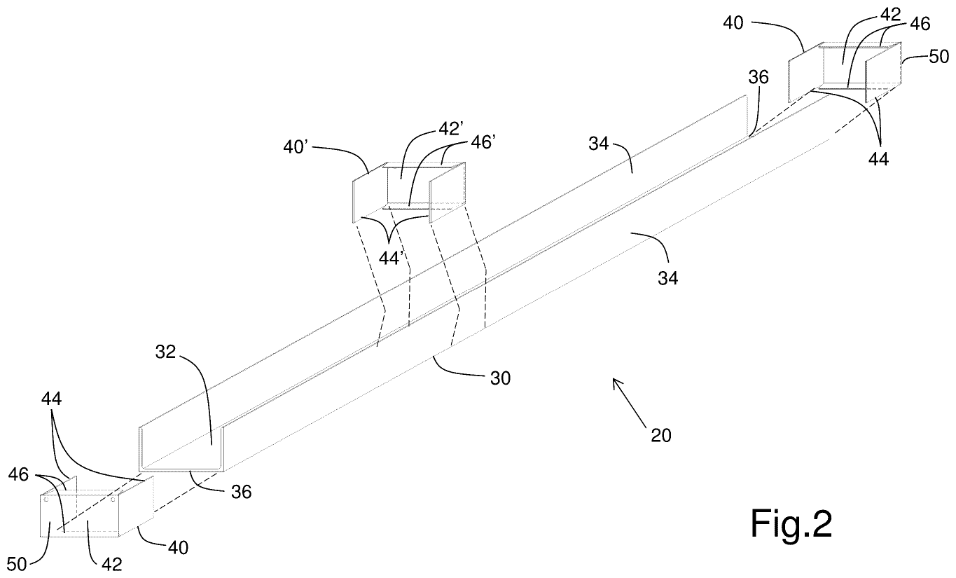

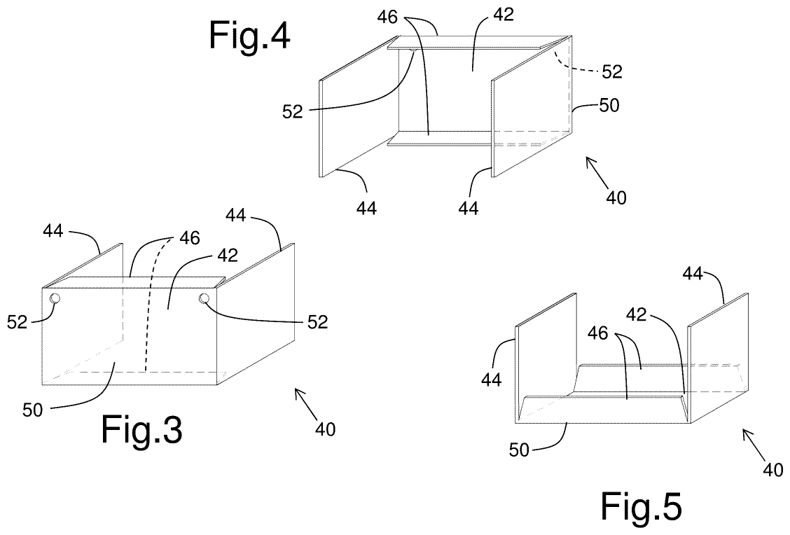

As better seen in FIG. 2, the door header 20 typically comprises a metallic elongate body 30 including at least a main bottom wall 32 and first and second longitudinal lateral walls 34 secured to the bottom wall 32 and being generally perpendicular thereto. The main bottom wall 32 and the longitudinal lateral walls 34 extend between first and second longitudinal ends 36. The elongate body 30 typically has a body length generally equal to the predetermined distance. Also, the door header 20 typically comprises first and second longitudinal end brackets 40 slidably inserting and securing to the metallic elongate body 30 adjacent the first and second longitudinal ends 36, respectively, and are securable to the two adjacent vertical studs 12. Typically, as better seen in FIGS. 3-5, each one of said first and second longitudinal end brackets 40 includes a bracket end wall 42 with two opposed bracket side tabs 44, and opposed bracket lower and upper tabs 46, all extending generally perpendicularly from the bracket end wall 42 opposite a stud facing surface 50 of the bracket end wall 42. Typically, at least one of the two opposed bracket side tabs 44 and the bracket lower tab 46 (which could be larger than the bracket upper tab) is securable to the first and second longitudinal lateral walls 34 and the main bottom wall 32, respectively, when each longitudinal end bracket 40 is secured at respective said longitudinal end 36.

Typically, each longitudinal end bracket 40 is secured to the elongate body 30 at a respective longitudinal end 36 via at least one, but preferably both opposed bracket side tabs 44, and preferably the bracket lower tab 46, using conventional fastening means such as screws, nails, rivets, welding, or the like.

The bracket end wall 42 of each longitudinal end bracket 40 typically includes at least one perforation 52 extending there through to allow a fastener (not shown), such as a screw, nail, rivet or the like, to be insertable through the at least one perforation 52, thereby securing the longitudinal end bracket 40, and therefore the door header 20, to one of the two adjacent vertical studs 12.

Typically and as better seen in FIG. 1, in order to properly secure the door header 20 to the two adjacent studs 12, an installation tool 80 is releasably secured to one of the adjacent stud 12, typically using a magnet fastener or the like (not shown), and the corresponding longitudinal end 36 is supported or held in place by the installation tool 80 while the door header 20 is being secured to the stud 12. Typically, the longitudinal end 36 is simply supported on a corresponding tool tab (not shown) of the installation tool 80 located thereunder. Alternatively, the installation tool 80 could also be located above the door header 20 and hold it in place for attachment via a magnet fastener or the like (not shown) attached to corresponding tool tab.

Typically, as illustrated in FIGS. 1 and 2, the door header 40 further includes a third end bracket 40′ with the two opposed bracket side tabs 44′ and the two opposed bracket lower and upper tabs 46′, the third end bracket 40′ being secured to the metallic elongate bod 30 typically between the first and second longitudinal ends 36 via fasteners (not shown), after being typically slidably (sliding the two side tabs 44′ inside between the two longitudinal lateral walls 34) and pivotally (pivoting the end wall 42′ between the two longitudinal lateral walls 34 to finally properly position the third end bracket 40') inserted therein (as illustrated with broken stippled lines in FIG. 2). The bracket end wall 42′ of the third end bracket 40′ is typically securable to a longitudinal end 14 of a transverse or third vertical stud 12′ slidably insertable into the metallic elongate body 30 adjacent the third end bracket 40′, with the longitudinal lateral walls 34 being securable to the third vertical stud 12′.

Although not specifically illustrated in the figures, each bracket side tab 44, 44′ could include a flap extending therefrom opposite the bracket end wall 42, 42′ and angled toward the other opposed bracket side tab 44, 44′, in order to facilitate the slidable insertion of the end bracket 40, 40′ into the elongated body 30.

Although the present invention has been described with a certain degree of particularity, it is to be understood that the disclosure has been made by way of example only and that the present invention is not limited to the features of the embodiments described and illustrated herein, but includes all variations and modifications within the scope of the invention as hereinabove described and hereinafter claimed.

1. A door header of a frame defining an opening in a stud wall having two adjacent vertical studs spaced from one another by a predetermined distance, the door header comprising:
a metallic elongate body including at least a main bottom wall and first and second longitudinal lateral walls secured to the bottom wall and being generally perpendicular thereto, the main bottom wall and the longitudinal lateral walls extending between first and second longitudinal ends, the metallic elongate body having a body length generally equal to the predetermined distance;
first and second longitudinal end brackets slidably inserting and securing to the metallic elongate body adjacent the first and second longitudinal ends, respectively, the first and second longitudinal end brackets being securable to the two adjacent vertical studs;
wherein each one of said first and second longitudinal end brackets including a bracket end wall with two opposed bracket side tabs, and opposed bracket lower and upper tabs, all extending generally perpendicularly from the bracket end wall opposite a stud facing surface of the bracket end wall, at least one of the two opposed bracket side tabs and the bracket lower tab being securable to the first and second longitudinal lateral walls and the main bottom wall, respectively, when each said longitudinal end bracket is secured at respective said longitudinal end.

2. The door header of claim 1, wherein the bracket end wall of each said longitudinal end bracket includes at least one perforation extending there through to allow a fastener to be insertable through the at least one perforation, thereby securing the longitudinal end bracket to one of the two adjacent vertical studs.

3. The door header of claim 2, further including a third end bracket with the two opposed bracket side tabs secured to the metallic elongate body between the first and second longitudinal ends, the bracket end wall of the third end bracket being securable to a longitudinal end of a third vertical stud slidably inserted into the metallic elongate body adjacent the third end bracket, the first and second longitudinal lateral walls being securable to the third vertical stud.

4. The door header of claim 3, wherein each said bracket side tab includes a flap extending therefrom opposite the bracket end wall and angled toward the other said bracket side tab.

5. The door header of claim 1, further including a third end bracket with the two opposed bracket side tabs secured to the metallic elongate body between the first and second longitudinal ends, the bracket end wall of the third end bracket being securable to a longitudinal end of a third vertical stud slidably inserted into the metallic elongate body adjacent the third end bracket, the first and second longitudinal lateral walls being securable to the third vertical stud.

6. The door header of claim 5, wherein each said bracket side tab includes a flap extending therefrom opposite the bracket end wall and angled toward the other said bracket side tab.

7. The door header of claim 1, wherein each said bracket side tab includes a flap extending therefrom opposite the bracket end wall and angled toward the other said bracket side tab.
